(19) United States
(12) Patent Application Publication
(10) Pub. No.: US 2024/0306268 A1
(43) Pub. Date: Sep. 12, 2024

(54) Glazing for Electric Heating, Method for Manufacturing the Same and Use of the Same

(71) Applicant: Pilkington Group Limited, Nr. Ormskirk Lancashire (GB)

(72) Inventor: Leigh Francis MELLOR, St Helens, Merseyside (GB)

(73) Assignee: Pilkington Group Limited, Nr. Ormskirk Lancashire (GB)

(21) Appl. No.: 18/264,629

(22) PCT Filed: Feb. 7, 2022
(86) PCT No.: PCT/GB2022/050315

§ 371 Date: Aug. 8, 2023

(30) Foreign Application Priority Data
Feb. 11, 2021 (GB) 2101924.5

(51) Int. Cl. H05B 3/84

(52) U.S. Cl. CPC H05B 3/84; H05B 2203/011

(57) ABSTRACT

A glazing for electric heating comprises a glass sheet, a conductive coating arranged on the glass sheet, a first deletion line in the conductive coating forming a heating area, a second deletion line having a contact with the first deletion line and extending in the heating area, first and second busbars at least partly on the heating area adjacent the first deletion line, and a crossover of first and second busbars at the contact between first and second deletion lines. Also disclosed is a method for manufacturing the glazing and use of the glazing, for example as a window of a vehicle.

### FIELD OF THE INVENTION

The invention is a glazing for electric heating, a method for manufacturing the same and use of the same, for example, as a window for a vehicle.

### BACKGROUND OF THE INVENTION

Glazings for electric heating having a conductive coating on a glass substrate are well known. Busbars to supply current to the conductive coating are often arranged near an edge of the glazing. In a side window of a vehicle the busbars may be along the bottom edge inside a door of the vehicle, or at a side edge adjacent a frame of the door.

DE102004029164A1 (Baranski/Pilkington) discloses a laminated glass pane having a conductive coating. Two busbars made of metal strips are covered with an insulation layer. Contact windows are provided in the insulation layer to make electrical contact with an assigned segment of the conductive coating.

US2016174295A1 (Klein/Saint-Gobain) discloses a heatable laminated side pane comprising a conductive coating, divided into segments by isolation lines. First and second busbars are formed as strips of conductive foil or fired printing paste.

DE102013007381A1 (Straube/Volkswagen) discloses a transparent pane with heatable coating and at least one busbar. The busbar is printed on the coating and comprises an insulation layer printed on top of a conductive layer.

There remains a need for an alternative glazing for electric heating, in particular having busbars arranged along at least one edge of the glazing.

### Objectives of the Invention

An objective of the invention is to provide a glazing for electric heating having, in use, a desired heat distribution for improved defrosting or demisting. Another objective is to provide a simple method for manufacturing a glazing for electric heating.

### SUMMARY OF THE INVENTION

In a first aspect, the present invention provides a glazing for electric heating comprising the features set out in claim 1.

The invention provides a glazing for electric heating, comprising a glass sheet, a conductive coating arranged on the glass sheet, a first deletion line in the conductive coating forming a heating area, a second deletion line having a contact with the first deletion line and extending in the heating area, first and second busbars at least partly on the heating area adjacent the first deletion line, and a crossover of first and second busbars at the contact between first and second deletion lines.

The invention is advantageous because a glazing having a crossover of first and second busbars has improved heat distribution compared with conventional glazing.

Surprisingly, a crossover of busbars arranged adjacent a first deletion line allows current flow along most of the length of the busbars, for uniform heating. A conventional glazing has an insulating layer covering most of the length of a busbar so current flows only through a contact window, causing hotspots.

A glazing according to the invention allowing current flow along most of the length of the busbars has faster defrosting or demisting than a conventional glazing.

The set of heating zones are connected as parallel circuits to first and second busbars between adjacent crossovers. Parallel circuits can be arranged to provide a desired heat distribution using fewer components than a conventional glazing.

A result of the invention is that the glazing meets industrial test requirements for defrosting, for example for a vehicle window.

Preferably, in use, current flows in a heated coating from the first busbar to the second busbar at least partly around the second deletion line.

Preferably, the conductive coating is a pyrolytically deposited transparent conductive oxide. More preferably, the coating is fluorine doped tin oxide deposited during a float glass manufacturing process at a temperature above 400° C.

Advantageously, a pyrolytically deposited coating is a hard coating, in contrast to a soft coating formed by sputtering. Alternatively, the coating is a sputtered coating having two, three or four layers of silver.

Preferably, the first deletion line in the conductive coating insulates the heating area from a non-heating area of the conductive coating. The first deletion line is advantageous because it avoids a need to remove a large area of conductive coating. Preferably, the first deletion line is a plurality of deletion lines. Preferably, the deletion lines in the plurality of deletion lines are parallel to one another and spaced apart from one another.

Preferably, the second deletion line extends in the non-heating area to an edge of the conductive coating adjacent first and second busbars to prevent electrical short circuit between busbars.

Preferably, the second deletion line comprises a deletion area at the crossover. The deletion area is advantageous because it provides an insulated region thus reducing the risk of an electrical short circuit.

Preferably, first and second busbars comprise conductive ink. Conductive ink is advantageous because it may be printed directly on the conductive coating using methods known in the art.

Preferably, an insulating layer is positioned between first and second busbars at the crossover. The insulating layer at the crossover saves cost because less insulating material is needed than in a conventional glazing having insulating material except at a contact window. In an advantageous embodiment, the insulating layer is non-conductive ink, preferably printed over the first busbar before printing the second busbar.

Preferably, the glazing comprises a first zone boundary having a contact with the first deletion line, and the first zone boundary extends in the heating area further than the second deletion line, and a crossover of first and second busbars is located at the contact between the first deletion line and the first zone boundary.

The zone boundary limits current flow within a zone, to control heat distribution in the heating area. In an advantageous embodiment, the zone boundary is a deletion line, preferably formed by laser deletion of the conductive coating. Preferably the zone boundary extends from the first deletion line to an opposite edge of the conductive coating. Preferably the zone boundary extends from the first deletion line in the non-heating area to the edge of the conductive coating.

Preferably, the glazing comprises a second zone boundary. Advantageously, the first zone boundary and the second zone boundary provide a zone area in which current flows between adjacent sections of first and second busbars either side of a crossover. Preferably in use a power density in the heating area of the conductive coating between first and second zone boundaries is in a range from 200 to 1,000 W/m², more preferably from 300 to 600 W/m². Power density in these ranges are desirable, for example for effective defrosting or demisting of a vehicle glazing.

In a second aspect, the present invention provides a method for manufacturing a glazing comprising the steps set out in claim 10.

The invention provides a method for manufacturing a glazing according to the invention, comprising steps: providing a glass sheet, arranging a conductive coating on a glass sheet, providing a first deletion line in the conductive coating, forming a heating area, configuring a second deletion line having a contact with the first deletion line and extending in the heating area; arranging first and second busbars at least partly on the heating area adjacent the first deletion line, and configuring a crossover of first and second busbars at the contact between first and second deletion lines.

Preferably, the method for manufacturing a glazing further comprises a step of pyrolytically depositing the conductive coating, preferably during manufacture of the glass sheet. Preferably, the coating is deposited by Chemical Vapour Deposition (CVD). The step of a pyrolytically depositing the conductive coating during manufacture of the glass sheet provides an alternative to sputtering and for a coating more durable in use.

Preferably, the method for manufacturing a glazing further comprises a step of forming the deletion line by laser deletion of the heated coating. The step of laser deletion provides an alternative to mechanical abrasion. Preferably the first deletion line and/or the second deletion line is formed by laser deletion of the heated coating.

Preferably, the method for manufacturing a glazing further comprises a step of printing the first busbar using conductive ink. The step of printing provides an alternative to stamping metal foil. Likewise, the second busbar may be applied after the first busbar by printing using conductive ink.

Preferably, the method for manufacturing a glazing further comprises a step of printing an insulating layer using non-conductive ink between the steps of printing first and second busbars using conductive inks. The step of printing an insulating layer using non-conductive ink provides an alternative to arranging an adhesive patch.

In a third aspect, the present invention provides use of a glazing according to the invention as a heated window of a vehicle for land, sea and air, for example as a windshield, a rear window, a side window or a roof window of a motor vehicle. The invention may also be used as an electric heater for a building, for example mounted on a wall or a window in a refrigerator door or in street furniture.

The invention will now be further disclosed by non-limiting drawings, non-limiting examples and a comparative example.

### BRIEF DESCRIPTION OF THE DRAWINGS

FIG. 1 is an embodiment of the invention having a crossover.

FIG. 2 is a cross-section of the embodiment of FIG. 1.

FIG. 3 is an embodiment of the invention having a deletion area.

FIG. 4 is a cross-section of the embodiment of FIG. 3.

FIG. 5 is an embodiment of the invention having an insulating layer.

FIG. 6 is a cross-section of the embodiment of FIG. 5.

FIG. 7 is an embodiment of the invention, having zone boundaries.

FIG. 8 is a cross-section of the embodiment of FIG. 7.

### DETAILED DESCRIPTION OF THE INVENTION

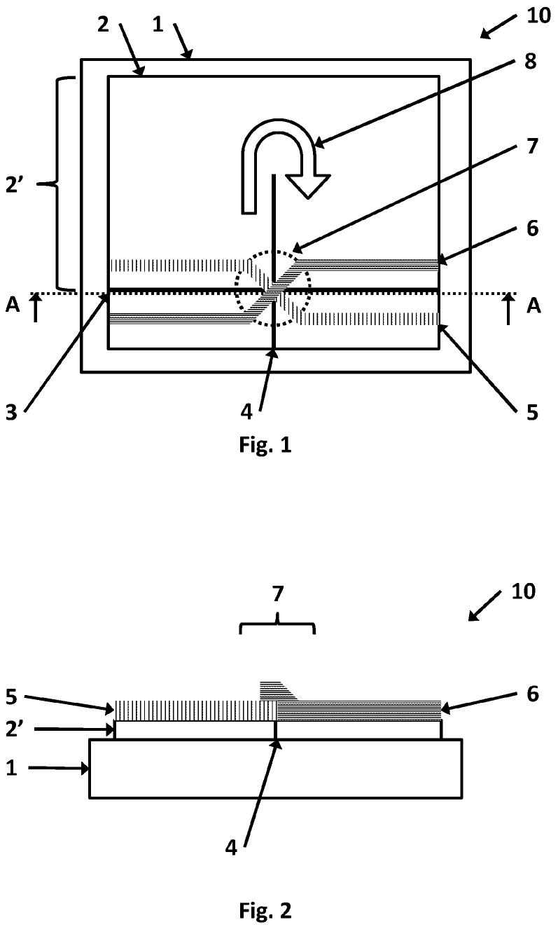

FIG. 1 discloses a glazing 10 for electric heating according to the invention comprising a glass sheet 1 and a conductive coating 2 arranged on a major surface of the glass sheet 1.

The glass sheet is preferably soda lime silica glass, manufactured using the float process. Glass thickness is preferably in a range from 2 to 12 mm. The glass sheet may be toughened glass with surface stress greater than 65 MPa, or heat strengthened glass with surface stress in a range from 40 to 55 MPa, or semi-toughened with surface stress in a range from 20 to 25 MPa, or annealed glass.

The glazing may be monolithic comprising only one glass sheet. Monolithic glazing is advantageous to save weight relative to laminated glass.

The glazing may be laminated glass, comprising first and second glass sheets having between them a ply of interlayer material, preferably polyvinyl butyral (PVB). Preferably the laminated glass has the conductive coating and busbars adjacent the ply of interlayer material. This is advantageous for a moveable window in a door because it reduces wear on seals between the window and the door frame. Laminated glass is also advantageous for safety.

The conductive coating 2 may comprise a transparent conductive oxide such as tin oxide or fluorine-doped tin oxide deposited on the glass sheet 1 during the glass manufacturing process.

A first deletion line 3 is provided in the conductive coating 2 forming a heating area 2′. In one embodiment of the invention, the first deletion line 3 is the full extent of the conductive coating 2 adjacent an edge of the glazing 10. In an advantageous embodiment, the first deletion line 3 is a laser deleted line in the conductive coating insulating a heating area and a non-heating area. The non-heating area is adjacent the edge of the glazing 10. For a side glazing of a vehicle, the non-heating area and a part of the heating area 2′ containing first and second busbars 5, 6 are at the bottom of the glazing 10, hidden from view inside a door of the vehicle. A remaining part of the heating area 2′ is visible when the side glazing is in a closed position.

A second deletion line 4 having contact with the first deletion line 3 extends in the heating area 2′. Where a non-heating area of the conductive coating 2 is provided, the second deletion line 4 also extends in the non-heating area to the full extent of the conductive coating 2 adjacent the edge of the glazing 10.

First and second busbars 5, 6 are arranged spaced from each other and in electrical contact with at least part of the heating area 2′ to form a heated coating 8.

In an advantageous embodiment, the heated coating 8 is partly bounded at a bottom edge by inner edges of first and second busbars 5, 6. First and second busbars 5, 6 may have any shape, for example straight, arcuate or a plurality of sections, each section being straight or arcuate. First and second busbars 5, 6 may comprise any conductive material, for example silver.

The heated coating 8 may be partly bounded, for example at left and right sides by left and right sides of the conductive coating 2.

Removal of conductive coating material may be by laser deletion, mechanical abrasion or other methods known in the art. Width of the coating-free lines is typically in a range from 10 μm to 5 mm.

FIG. 2 is a cross-section on a line A-A of the embodiment of FIG. 1. First busbar 5 extends from the contact between the first and second deletion lines 3, 4 to the left in the heating area 2′. Second busbar 6 extends from the contact between the first and second deletion lines 3, 4 to the right in the heating area 2′. The crossover 7 of busbars is indicated as two wedges, but this is not limiting.

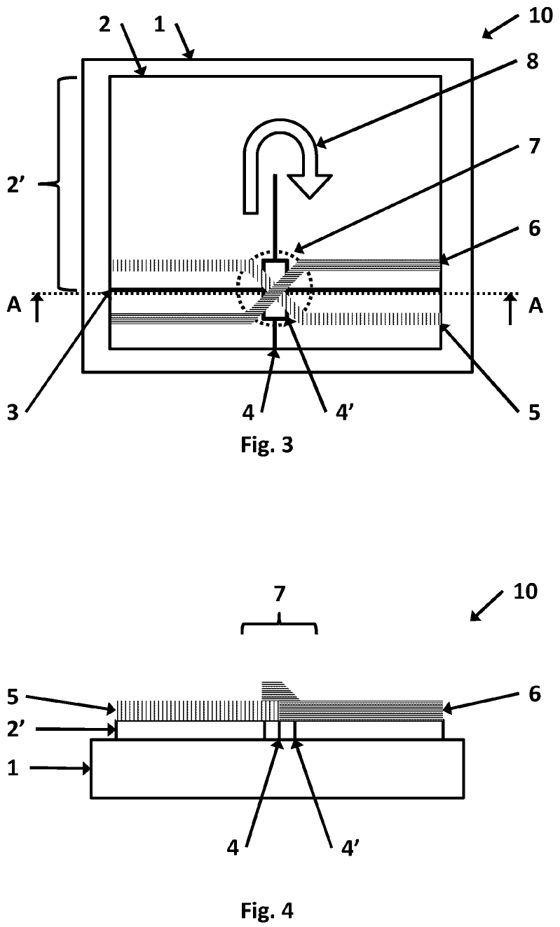

FIG. 3 discloses an embodiment of the invention having a deletion area 4′. Width, length and shape of the deletion area 4′ are not limited. Shape of the deletion area 4′ is shown as a rectangle but can be any shape formed of straight or arcuate lines, or a combination of straight and arcuate lines.

FIG. 4 is a cross-section on a line A-A of the embodiment of FIG. 3. The deletion area 4′ may be formed by laser deletion or mechanical abrasion, similar to the second deletion line 4. The deletion area 4′ may be fully deleted as shown, or may comprise a pattern of deletion lines, such as a grid.

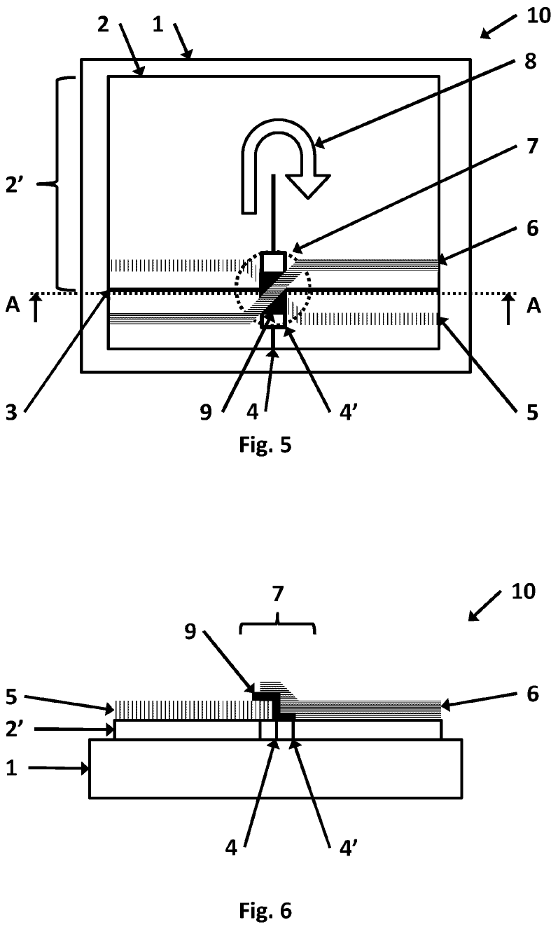

FIG. 5 discloses an embodiment of the invention having an insulating layer 9. Width, length, and shape of the insulation layer 9 are not limited, except that the insulation layer must fully insulate the overlap between first and second busbars 5, 6 to avoid a short circuit.

FIG. 6 is a cross-section on a line A-A of the embodiment of FIG. 5. The insulation layer 9 is preferably printed using non-conductive ink or provided as an adhesive patch.

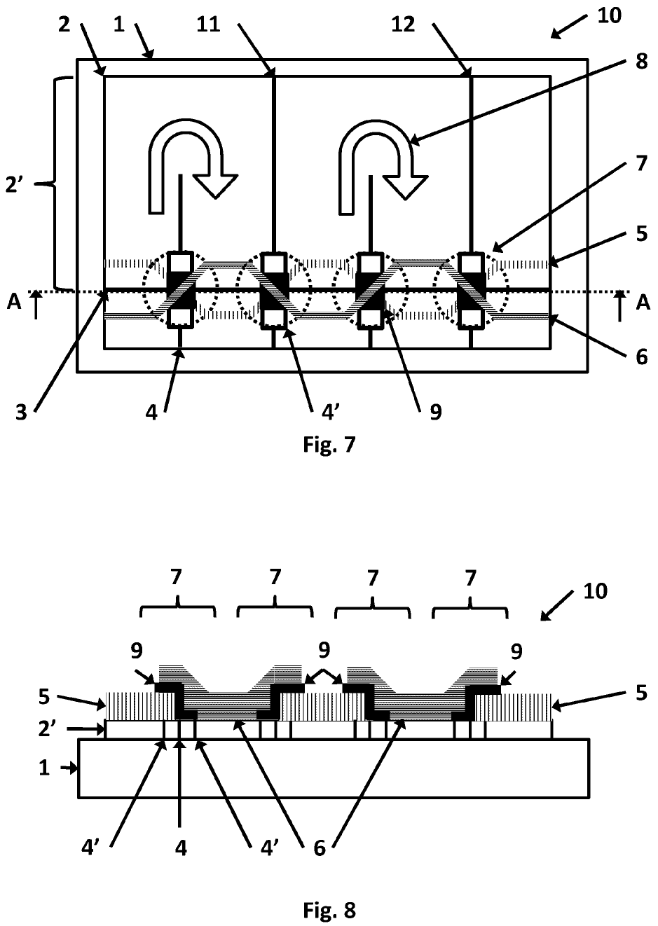

FIG. 7 discloses an embodiment of the invention, having first and second zone boundaries 11, 12 and two zone areas. First zone area is on the left and is a heated coating 8 bounded by a left edge of the conductive coating 2 and the first zone boundary 11. Second zone area is to the right of the first zone area and is a heated coating 8 bounded by first and second zone boundaries 11, 12. Second zone area is also bounded by the top edge of the conductive coating 2, first and second busbars 5, 6 and three deletion areas 4′.

FIG. 8 is a cross-section on a line A-A of the embodiment of FIG. 7. In this embodiment, each of four crossovers has a deletion area 4′ and an insulating layer 9. Advantageously, each crossover has a positional tolerance to accommodate positional variation in the method of applying first and second busbars relative to the second deletion lines and first and second zone boundaries.

### KEY TO THE DRAWINGS

References in the drawings are as follows:
1—First glass sheet
2—Conductive coating
2′—Heating area
3—First deletion line
4—Second deletion line
4′—Deletion area
5—First busbar
6—Second busbar
7—Crossover
8—Heated coating
9—Insulating layer
10—Glazing
11—First zone boundary
12—Second zone boundary

1. A glazing for electric heating, comprising:
a glass sheet;
a conductive coating arranged on the glass sheet;
a first deletion line in the conductive coating forming a heating area;
a second deletion line having a contact with the first deletion line and extending in the heating area;
first and second busbars at least partly on the heating area adjacent the first deletion line; and
a crossover of first and second busbars at the contact between first and second deletion lines.

2. A glazing according to claim 1, wherein in use current flows in a heated coating from the first busbar to the second busbar at least partly around the second deletion line.

3. A glazing according to claim 1, wherein the conductive coating is a pyrolytically deposited transparent conductive oxide.

4. A glazing according to claim 1, wherein the first deletion line insulates the heating area from a non-heating area of the conductive coating.

5. A glazing according to claim 1, wherein the second deletion line comprises a deletion area at the crossover.

6. A glazing according to claim 1, wherein first and second busbars comprise conductive ink.

7. A glazing according to claim 1, further comprising an insulating layer between first and second busbars at the crossover.

8. A glazing according to claim 1, further comprising a first zone boundary having a contact with the first deletion line and extending in the heating area further than the second deletion line and a crossover of first and second busbars is located at the contact between the first deletion line and the first zone boundary.

9. A glazing according to claim 1, further comprising a second zone boundary and in use a power density in the heating area between first and second zone boundaries is in a range from 200 to 1,000 W/m².

10. A method for manufacturing a glazing for electric heating, according to claim 1, comprising:
providing the glass sheet;
arranging the conductive coating on the glass sheet;
providing the first deletion line in the conductive coating forming the heating area;
configuring the second deletion line having the contact with the first deletion line and extending in the heating area;
arranging the first and second busbars at least partly on the heating area adjacent the first deletion line; and
configuring the crossover of first and second busbars at the contact between first and second deletion lines.

11. A method for manufacturing a glazing according to claim 10, further comprising pyrolytically depositing the conductive coating during manufacture of the glass sheet.

12. A method for manufacturing a glazing according to claim 10, further comprising forming the first deletion line and/or the second deletion line by laser deletion of the conductive coating.

13. A method for manufacturing a glazing according to claim 10, further comprising printing the first busbar using conductive ink.

14. A method for manufacturing a glazing according to claim 10, wherein the arranging of the first and second busbars at least partly on the heating area comprises printing the first and second busbars using conductive inks, the method further comprising printing an insulating layer using non-conductive ink, the printing of the insulating layer occurring between the printing of the first busbar and the printing of the second busbar.

15. Use of the glazing according to claim 1 as a windshield, a rear window, a side window, or a roof window of a motor vehicle or as a heater in a building or a window in a refrigerator door or in street furniture.

16. A glazing according to claim 1, further comprising a second zone boundary and in use a power density in the heating area between first and second zone boundaries is in a range from 300 to 600 W/m².
